(19) United States
(12) Patent Application Publication
(10) Pub. No.: US 2018/0119613 A1
(43) Pub. Date: May 3, 2018

(54) HYBRID COMBUSTION TURBINE POWER GENERATION SYSTEM

(71) Applicant: ENERGY TECHNOLOGIES INSTITUTE LLP, Leicestershire (GB)

(72) Inventor: James MACNAGHTEN, Hampshire (GB)

(21) Appl. No.: 15/553,153

(22) PCT Filed: Mar. 2, 2016
(86) PCT No.: PCT/GB2016/050546

§ 371 Date: Aug. 23, 2017

(30) Foreign Application Priority Data
Mar. 6, 2015 (GB) 1503848.2

(51) Int. Cl. F02C 6/16; F02C 7/10; F02C 9/16

(52) U.S. Cl. CPC F02C 6/16; F02C 3/04; F02C 9/16; F02C 7/10

(57) ABSTRACT

Some embodiments are directed to a hybrid combustion turbine power plant including a conventional gas turbine, integrated via a fluid connection allowing air injection or extraction, with an adiabatic compressed air energy storage system (ACAES) including a direct TES (thermal energy store) and, downstream thereof, a supplementary compressor and pressure reducing device disposed in alternative pathways between the direct TES and compressed air store. The ACAES discharges air into the gas turbine via the fluid connection at a desired mass flow rate through the pressure reducing device, and charges with air via the supplementary compressor at a lower mass flow rate over a longer period of time, trickle charging allowing the use of a low power supplementary compressor. The use of a direct TES (40) efficiently returns the heat of compression. Alternatively, variable mass flow, reversible power machinery and a second TES may be provided downstream of the direct TES.

### CROSS REFERENCE TO RELATED APPLICATIONS

This application is a national phase filing under 35 C.F.R. § 371 of and claims priority to PCT Patent Application No. PCT/GB2016/050546, filed on Mar. 2, 2016, which claims the priority benefit under 35 U.S.C. § 119 of British Patent Application No. 1503848.2, filed on Mar. 6, 2015, the contents of each of which are hereby incorporated in their entireties by reference.

### BACKGROUND

Some embodiments relate to a hybrid combustion turbine power generation system, a retrofit method for producing the same and a method of operation. In particular, some embodiments are concerned with a hybrid system in which a conventional combustion turbine is integrated with an adiabatic compressed air energy storage (ACAES) system.

CAES systems utilizing thermal energy storage (TES) apparatus to store heat have been known since the 1980's. In particular, ACAES systems store the heat of compression of the compressed air in thermal stores for subsequent return to the air as it leaves a compressed air store before undergoing expansion. The TES apparatus may contain a thermal storage medium through which the compressed air passes, releasing heat to the storage medium, thereby heating the store and cooling the air. The thermal storage medium may be in the form of a porous storage mass, which may be a packed bed of solid particles through which the air passes exchanging thermal energy directly, or, it may include a solid matrix or monolith provided with channels or interconnecting pores extending therethrough, or, the fluid may pass through a network of heat exchange pipes that separate it from the storage mass, such as a packed bed of particles (e.g. rocks). Alternatively, the compressed air may pass through a heat exchanger that is coupled to a separate thermal store, such that heat is transferred indirectly to the latter via a heat transfer fluid, in which case the thermal store need not be pressurised and could include a thermal storage medium such as a molten salt or high temperature oil.

It will be appreciated that where the storage of sensible heat in the TES apparatus is optimised, then the overall energy storage capacity of an ACAES will also be enhanced. Thermal energy stores based on direct thermal transfer have much higher efficiencies than ones that store heat indirectly (e.g. usually involving heat exchangers coupled to remote stores via heat transfer fluid loops). Applicant's earlier application WO2012/127178 proposes direct thermal transfer TES apparatus wherein the storage media is divided up into separate respective downstream sections or layers. The flow path of the heat transfer fluid through the layers can be selectively altered using valving in the layers so as to access only certain layers at selected times, so as to avoid pressure losses through inactive sections upstream or downstream of the sections where the thermal front is located and to maximise store utilisation. TES apparatus incorporating layered storage controlled by valves (more particularly, direct transfer, sensible heat stores incorporating a solid thermal storage medium disposed in respective, downstream, individually access controlled layers) can provide very efficient storage of heat up to temperatures of 600° C. or even hotter. It should be noted that the flow velocity through such a bed may be as low as 0.5 m/s or even lower, promoting efficient thermal exchange.

Air injected power augmentation of combustion turbines is used to increase the power output of a gas turbine up to its normal maximum allowable power where, for example, the power has dropped due to high altitude or high ambient temperatures reducing the density of inlet air. Externally compressed, heated air is injected into the gas turbine upstream of the combustor in order to improve the power output.

U.S. Pat. No. 5,934,063 to Nakhamkin proposes a hybrid combustion turbine power generation (CTPGS) system in which a gas turbine is integrated with an ACAES system and pressurised air from the air storage is injected at the combustor to augment the air flow through the gas turbine and hence increase the power output when it would otherwise be below its maximum allowable level. A supplemental compressor with its own air inlet supplies the air to the air storage, or, that supplemental compressor is fed by the main compressor (while the combustor is unfired and the turbine merely receives a cooling flow from the air store). This system has valve structure that selectively permits each of the following modes of operation: a normal gas turbine power generation mode, an augmented gas turbine power generation mode, and a storage mode.

According to WO2013/116185, U.S. Pat. No. 5,934,063 has not been implemented because it is high in cost and complexity and lacks a practical method to heat the air up prior to injection after storage. The teaching in U.S. Pat. No. 5,934,063 is either to preheat the returning stored air with waste heat from the turbine (in the case of a Simple Cycle Gas Turbine SCGT), or waste heat from a steam turbine (in the case of a Combined Cycle Gas Turbine CCGT), either of which cause an efficiency penalty at the turbine concerned. As an alternative, WO2013/116185 instead proposes, inter alia, the use of various heat exchanger stages during the storage mode to store the heat of compression for subsequent return. It also proposes a storage mode in which some pressurised gas is extracted from the gas flow passing down through the gas turbine while it is operating and producing power otherwise normally.

As a related matter, there have also been various proposals to provide a combustion turbine (GT) system integrated with an adiabatic compressed air energy storage ACAES system, with a decoupling device such that the compressor may be selectively coupled and decoupled from the turbine in order to allow their independent operation such that the gas turbine can operate in multiple modes; selector valve arrangements may be disposed within the GT flowpath to divert the airflow into and out of the GT in these multiple modes. However, to date no commercial systems exist due to the cost and complexity of developing such a decouplable gas turbine system.

### SUMMARY

Some embodiments are directed towards providing an improved hybrid combustion turbine power generation system.

In accordance with a first aspect of the present invention, there is provided a hybrid combustion turbine power generation system (CTPGS) including:
a combustion turbine (GT) system including a compressor, a combustor and a turbine fluidly connected downstream of each other, wherein the turbine is non-detachably coupled to the compressor and is operatively associated with a generator for power generation,
and an adiabatic compressed air energy storage system (ACAES) integrated therewith via one or more fluid connections disposed between the compressor and turbine, so as to allow air to be extracted from, and/or injected into, the GT system (e.g. upstream of the turbine);
wherein the ACAES includes a flow passageway network and associated valve structure leading from the one or more fluid connections to a compressed air store via at least one direct thermal energy store (TES),
there being further disposed within the flow passageway network (i) an optional, charging compressor and associated air inlet disposed between the one or more fluid connections and the at least one direct TES for charging the compressed air store, and (ii) a supplementary (e.g. second stage) compressor and a pressure reducing device disposed in alternative respective flow pathways between the at least one direct TES and the compressed air store,
wherein the flow passageway network and associated valve structure is configured to allow selective operation of the ACAES in both:
a charging mode in which compressed air at a first mass flow rate is supplied by the compressor of the GT system and/or the optional charging compressor to the at least one direct TES, where it passes through and is cooled by the at least one direct TES, and the compressed, cooled air is further compressed by the supplementary compressor before being stored in the compressed air store; and,
a discharging mode, in which pressurised air from the compressed air store at a second mass flow rate that is higher than the first mass flow rate, is expanded by the pressure reducing device, and passes through the at least one direct TES where it is heated, before passing via the one or more fluid connections back into the combustor to supplement the air flow therethrough; and,
wherein the CTPGS is configured to allow selective operation in at least each of the following operating modes:
(i) a normal power generation mode in which air passes respectively downstream through the compressor, combustor and turbine of the GT system to generate power, but the air flow is not partially supplemented or extracted;
(ii) another power generation mode in which air passing respectively downstream through the compressor, combustor and turbine of the GT system to generate power is supplemented by the injection, at the one or more fluid connections, of pressurised air that is returning at the second mass flow rate from the compressed air store of the ACAES system as it operates in the discharging mode specified above; and,
(iii) a storage mode in which:
(a) compressed air from the charging compressor, when present, is supplied at the first mass flow rate to the at least one direct TES, and the GT system is either inactive, or, is active and generating power; and/or,
(b) compressed air is extracted via the one or more fluid connections from the GT system and supplied at the first mass flow rate to the at least one direct TES.

In this way, a relatively low cost hybrid power generation system may be produced in which the GT system may run in another power generation mode usually to augment its power e.g. at or close to its allowable maximum capability, facilitated by the pressure reducing device permitting discharge at the second mass flow rate over a desired period of time, whilst the CAES system conveniently charges at a lower first mass flow rate over a longer period of time. The lower the first mass flow rate on charging e.g. trickle charging, the lower power and the less expensive the supplementary compressor needs to be.

The use of a direct TES efficiently returns the heat of compression. Thus the gas exiting the direct TES may enter the combustor directly without a further heating stage being required. The reason why a direct TES is required is that it is more suited than a heat exchanger to the fast response required for a gas turbine requiring immediate power augmentation. A heat exchanger cools down when inactive and hence requires a “warm-up” period. By contrast, a direct TES store retains the heat and is available for immediate usage. Also, a direct TES can better provide the fast and efficient heat transfer required upon discharge due to the higher discharge rate; in order for a heat exchanger to meet that it would need to be very large (oversized as compared with the requirement for the charging mode). Moreover, the configuration of the store may be altered to cope with a faster discharge rate using a larger area (e.g. wider) store with a shorter length. As discussed below, the use of a layered direct TES is also highly advantageous.

By “pressure reducing device” is meant a device that allows air to expand without doing work as it emerges from the store at the higher discharge flow rate, and this may be a throttle valve, expansion valve or similar device. The device should ideally regulate mass flow through it (or, for example, be followed (e.g. immediately downstream) by a device that regulates mass flow) to avoid uncontrolled mass flow. Such a device may be selected from a gate valve, ball valve, plug valve, butterfly valve or similar type valve and may use electronic or mechanical feedback to throttle the flow; hence, it may be simple and inexpensive in contrast to power machinery e.g. a turbine, which would capture the work of expansion (and be efficient) but in order to handle the higher discharge flow rate would be large/expensive.

The present invention is concerned with power modulation of a conventional combustion turbine GT system i.e. one in which the compressor, combustor and turbine are (permanently) fluidly connected downstream of each other (i.e. without any valve arrangements interposed directly within the gas turbine flow pathway to divert gas flow into or out of the GT flow pathway) so that whenever the gas turbine is operating to produce power at least some air flow passes successively downstream through all those components in turn (regardless of whether or not part of the flow is being extracted or added at the one or more fluid connections), and one where the turbine is non-detachably coupled to the compressor so that both operate together whenever power is generated.

In one embodiment, the second mass flow rate is at least twice the first mass flow rate. The second mass flow rate may be at least twice the first mass flow rate or at least five times, or at least seven times the first mass flow rate. Alternatively, the mass flow rate may be higher than the first mass flow rate such that the same amount of air is discharged from storage at least twice, five times or seven times as quickly as it was charged to storage.

In one embodiment, in the charging mode, some of the compressed air passing through the GT system is extracted at the one or more fluid connections and supplied at the first mass flow rate to the at least one direct TES. This embodiment is simpler and lower cost in that it requires no additional apparatus since the GT compressor itself acts as the first stage compressor supplying the compressed air to the TES; however, if no other changes are made to the operation of the GT, the extraction of a fraction of the GT airflow will lead to a reduction in power related to the quantity of air removed during that charging mode and, of course, the ACAES may only charge whilst the GT system is active and generating power.

A relatively small fraction, for example, usually less than 10%, or less than 8%, or even less than 6% or 3% of the total mass flow through the GT (e.g. at turbine inlet) will be bled out. Since the mass flow rate on discharge is higher than the mass flow rate on charge (usually at least twice as high), then usually less than 20%, or 16%, or 12% or 6% of the total mass flow through the GT will be injected back into the GT from storage (and/or the charging compressor, as described below).

The ACAES is integrated with the GT system via the one or more fluid connections disposed between the compressor and turbine; for example, these may be located at the compressor housing/outlet, at the combustor or in the combustor casing, or at the expander inlet, and allow air to be withdrawn from, or injected, into the fluid flowing through the combustion turbine. Some or all of the injected pressurised air may be combusted in the combustor depending on the location of the fluid connection(s).

The fluid connection may be an existing or modified (e.g. enlarged) or retrofitted inlet/outlet such as an opening or port (e.g. bleed port) in the GT (for example, a bleed port in the combustor casing), that is fluidly connected to the flow passageway network of the ACAES. Both aspects of the invention relate to a conventional gas turbine where the compressor, combustor, and the turbine associated with the combustor, are always fluidly connected, for example, without any valve arrangements directly in the gas turbine flow pathway that could selectively divert gas flow into or out of the GT flow pathway (as in the case of decouplable prior art modified GT systems). Thus it is not intended to cover an ACAES integrated with a GT system via a flow connection that is a valve/valve arrangement interposed within the gas turbine flow pathway, such that the gas turbine components are selectively but not permanently fluidly connected to each other.

The mass flow rate of the pressurised air into that opening or port may be controlled by a flow control valve located closely downstream in the ACAES flow passageway network, for example, to ensure the airflow through the GT does not exceed a certain value.

The one or more fluid connections may be provided upstream of the turbine inlet as a retrofit adaptation This may include retrofitting openings or ports, for example, in a combustor casing, and may also include retrofitting one or more manifolds surrounding groups of ports to deliver gas in a uniform manner. In this embodiment, the mass flow rate during charging is set by the supplementary compressor, which is advantageously a low power (often less than 30 MW, or even less than 15 MW) compressor that extracts the compressed air at a mass flow rate of usually not more than 10%, or 8% or 6% of the GT mass flow rate (e.g. at turbine inlet). For example, to compress ambient air from 1 bar to 17 bar may use 450 kW at a flow rate of 1 kg/s, whereas to compress the ambient temperature air from 17 bar to 40 bar may only use 100 kW at a flow rate of 1 kg/s. Hence, the supplementary (i.e. second stage) compressor only needs to supply up to about 20-25% of the work of the first stage of compression (e.g. charging compressor).

In one preferred embodiment, the charging compressor having the associated air inlet is provided between the one or more fluid connections and the direct TES and, in the charging mode, compressed air at the first mass flow rate is supplied by the charging compressor to the at least one direct TES. This embodiment has a higher initial cost and requires additional power for, for example, a motor operatively associated with the charging compressor. The GT system may either be inactive or may be generating power whilst the CAES system is operating in charging mode.

Compressed air at the first mass flow rate may be supplied to the at least one direct TES by extraction from the GT system as well as being supplied by the charging compressor. Thus, compressed air may be supplied in the charging mode by both the charging compressor and the compressor of the active GT system (i.e. “bleed air”), providing the mass flow rate does not exceed the maximum mass flow rate of the downstream supplemental compressor.

In one embodiment, a flow regulating valve is provided in the flow passageway network between the one or more fluid connections and the direct TES that controls the flow rate in a discharging mode so as to regulate the GT power output. This may be a pressure reducing valve that regulates mass flow, for example, using electronic or mechanical feedback. During the discharging mode, pressure fluctuations downstream of the first TES (which may experience a larger pressure drop across it in discharging mode as opposed to charging mode) mean that a flow regulating/control valve between the one or more fluid connections and the direct TES may be desirable for fine flow control thereby finely modulating the GT power output.

In one embodiment, the at least one direct TES includes a direct transfer, sensible heat store including a solid thermal storage medium disposed in respective, downstream, individually access controlled layers. The at least one direct TES includes at least one thermal energy store through which the compressed air has a flow path for direct exchange of thermal energy to a thermal storage medium contained within the thermal energy store; this may be a porous (solid) thermal mass in the form of, for example, a packed bed or particulate, especially a layered particulate store. Thus, flow may be directed through only a selected layer or a set of adjacent layers where heat transfer is actively occurring and layers either side of that active transfer region of the store may be by passed, for example, by the provision of respective bypass valves in each layer that allow flow to bypass the thermal storage medium in that respective layer.

The compressed air store may include a variable pressure, compressed air store.

In this instance, the supplementary compressor should be suitable for operation over the varying pressure ratio associated with the operational pressure range of the compressed air store. However, the store may be a constant pressure air store; there are various proposals in the prior art for constant pressure air stores such as underwater storage which would allow the supplementary compressor to work over a fixed or nearly fixed pressure ratio.

The compressed air store may include one or more gas pipelines and/or a cavern. Where the system is based on trickle charging at a suitably low mass flow rate allowing the use of a low power supplementary compressor, then the initial cost of a CAES pipeline may be recouped within a time span of only a few years.

The ACAES may operate in a charge mode, a storage mode, or a discharge mode at any one time, as well as being completely inactive. Thus, the flow passageway network and associated valve structure may also be configured to allow selective operation of the ACAES in a storage mode in which heat is stored in the at least one direct TES while compressed air is stored in the compressed air store, and no air is being passed into or out of storage. The valve structure may include an on/off valve or flow regulating valve between the one or more fluid connections and the first direct TES that can be opened and closed. The valve structure may also include one or more selector valves located between the first direct TES and the compressed air store, that allow the flow to be switched to flowing in either one of the alternative (e.g. in parallel) respective flow pathways (between the at least one direct TES and the compressed air store) in which the supplementary compressor (used on charging) and the a pressure reducing device (used on discharging) are disposed.

In addition, where the charging compressor is present, the CTPGS may be configured to allow selective operation in the following further operating mode:

(iv) a further power generation mode in which pressurised air is supplied from the charging compressor to the GT system and injected at the one or more flow connections to supplement the airflow in the GT system.

In a yet further power generation mode, if desired, there may be no discharge from the compressed air store and the charging compressor, when present, may simply augment the air passing respectively downstream through the compressor, combustor and turbine of the GT system. While such a mode will require power to be supplied to the charging compressor, usually the increase in GT power output will be much larger; for example, 3 MW supplied to the charging compressor may result in a 6 MW increase in power output. This may be useful where, for example, the ACAES has fully discharged but power augmentation is still required.

In addition, the CTPGS may be configured to allow selective operation in the following further operating mode:

(v) an alternative further power generation mode in which, in addition to the pressurised air supplied from the charging compressor as described above, pressurised air returning from the compressed air store is injected at the one or more flow connections to supplement the airflow in the GT system usually to further augment power.

In addition, the CTPGS may be configured to allow selective operation in a following further operating mode in which pressurised air is supplied from the charging compressor to the GT system and injected at the one or more flow connections to supplement the airflow in the GT system but some of that pressurised air is drawn down to storage by operating the supplementary compressor at a selected mass flow rate.

There is further provided, in accordance with the first aspect, a method of operating a hybrid combustion turbine power generation system (CTPGS) including:

a combustion turbine (GT) system including a compressor, a combustor and a turbine fluidly connected downstream of each other, wherein the turbine is non-detachably coupled to the compressor and is operatively associated with a generator for power generation,

and an adiabatic compressed air energy storage system (ACAES) integrated therewith via one or more fluid connections disposed between the compressor and turbine, so as to allow air to be extracted from, and/or injected into, the GT system (e.g. upstream of the turbine);

wherein the ACAES includes a flow passageway network and associated valve structure leading from the one or more fluid connections to a compressed air store via at least one direct thermal energy store (TES),

there being further disposed within the flow passageway network (i) an optional, charging compressor and associated air inlet disposed between the one or more fluid connections and the at least one direct TES for charging the compressed air store, and (ii) a supplementary (e.g. second stage) compressor and a pressure reducing device disposed in alternative respective flow pathways between the at least one direct TES and the compressed air store,

wherein the flow passageway network and associated valve structure is configured to allow selective operation of the ACAES in both:

a charging mode in which compressed air at a first mass flow rate is supplied by the compressor of the GT system and/or the optional charging compressor to the at least one direct TES, where it passes through and is cooled by the at least one direct TES, and the compressed, cooled air is further compressed by the supplementary compressor before being stored in the compressed air store; and,

a discharging mode, in which pressurised air from the compressed air store at a second mass flow rate that is higher than the first mass flow rate, is expanded by the pressure reducing device, and passes through the at least one direct TES where it is heated, before passing via the one or more fluid connections back into the combustor to supplement the air flow therethrough; and,

the method including:

selectively operating the CTPGS in at least each of the following operating modes:

(i) a normal power generation mode in which air passes respectively downstream through the compressor, combustor and turbine of the GT system to generate power, but the air flow is not partially supplemented or extracted;

(ii) another power generation mode in which air passing respectively downstream through the compressor, combustor and turbine of the GT system to generate power is supplemented by the injection, at the one or more fluid connections, of pressurised air that is returning at the second mass flow rate from the compressed air store of the ACAES system as it operates in the discharging mode specified above; and,

(iii) a storage mode in which:

(a) compressed air from the charging compressor, when present, is supplied at the first mass flow rate to the at least one direct TES, and the GT system is either inactive, or, is active and generating power; and/or,

(b) compressed air is extracted via the one or more fluid connections from the GT system and supplied at the first mass flow rate to the at least one direct TES.

There is further provided, in accordance with the first aspect, a retrofit method in which an ACAES as specified above is retrofitted to an existing combustion turbine system as specified above in order to obtain a hybrid CTPGS as specified above.

In particular, there is provided a method of retrofitting an existing combustion turbine (GT) system at a power plant to incorporate an adiabatic compressed air energy storage (ACAES) system so as to provide a hybrid combustion turbine power generation system (CTPGS) as specified above, including (in any suitable order) the steps of:

a) installing at least one direct thermal energy store (TES) at the site of the existing GT system, which includes a compressor, a combustor and a turbine fluidly connected downstream of each other, wherein the turbine is non-detachably coupled to the compressor and is operatively associated with a generator for power generation;

b) providing or modifying one or more fluid connections disposed between the compressor and turbine, so as to allow air to be extracted from, and/or injected into, the GT system;

c) installing a flow passageway network and associated valve structure leading from the one or more fluid connections to a compressed air store via the at least one direct (TES);

d) optionally installing within the flow passageway network a charging compressor and associated air inlet disposed between the one or more fluid connections and the at least one direct TES for charging the compressed air store;

e) installing a supplementary (e.g. second stage) compressor and a pressure reducing device disposed in alternative respective flow pathways within the flow passageway network between the at least one direct TES and the compressed air store; and,

f) configuring the hybrid CTPGS to operate as specified above.

In accordance with a second aspect of the present invention, there is provided a hybrid combustion turbine power generation system (CTPGS) including:

a combustion turbine (GT) system including a compressor, a combustor and a turbine fluidly connected downstream of each other, wherein the turbine is non-detachably coupled to the compressor and is operatively associated with a generator for power generation,

and an adiabatic compressed air energy storage system (ACAES) integrated therewith via one or more fluid connections disposed between the compressor and turbine, so as to allow air to be extracted from, and injected into, the GT system (e.g. upstream of the turbine);

wherein the ACAES includes a flow passageway network and associated valve structure leading from the one or more fluid connections to a compressed air store via a first direct thermal energy store (TES);

wherein a second, higher pressure stage, variable mass flow, reversible power machinery (that expands the gas doing useful work), and a second thermal energy store (TES) are arranged successively downstream (in the charging direction) of one another in the fluid passageway network;

wherein the hybrid CTPGS is operable in a power generation mode in which air passes respectively downstream through the compressor, combustor and turbine of the GT system to generate power;

and wherein, in that mode, the reversible power machinery is configured selectively to modulate the power output of the GT system in each of the following ways:
i. by operating as a compressor and selectively adjusting its mass flow rate to vary (e.g. increase and decrease) the rate at which air is extracted from the GT system and passed to the compressed air store in an ACAES charging mode;
ii. by operating as an expander and selectively adjusting its mass flow rate to vary (e.g. increase and decrease) the rate at which it withdraws air from the compressed air store for injection into the GT system in an ACAES discharging mode; and,
iii. by switching between acting as a compressor to acting as an expander, or vice versa, so as to switch the ACAES from a charging mode in which air is being extracted from the GT system to a discharging mode in which air is being injected into the GT system, and vice versa.

In this way, when a gas turbine is operating below its maximum allowable operating power (which is usually the case unless, for example, the ambient temperature has dropped to the lowest seasonal value), the second, higher pressure stage, variable mass flow, reversible power machinery can modulate the output power of the power turbine in a rapid manner within a useful power range (e.g. up to +/−5% or even up to +/−8 or 10%), with the rate being finely adjusted in i) and ii) above, or, more coarsely by reversing functionality as in iii) above. It should be noted that small, low cost, reversible power machinery of about 5 MW that is able to handle a mass flow rate of not more than 40 kg/s can nevertheless adjust the CCGT power output within a range of +/−40 MW up to its maximum allowable operating power. In addition the 5 MW used by the reversible power machinery adds to this number ie in total+/−45 MW variation for the CCGT. Low power reversible power machinery of not more than 20 MW, or even not more than 10 MW in power, may therefore be used for significant power modulation.

In the ACAES discharging mode, the GT system is operating in an air injection mode in which its power is increased, to a greater or lesser degree, by supplementing the GT air flow with pressurised air injected at the one or more fluid connections from the storage sub-system. In the ACAES charging mode, the GT system is operating in an air extraction mode in which its power is decreased, to a greater or lesser degree, by extracting some of the GT air flow at the one or more fluid connections into the storage sub-system.

The ACAES includes a flow passageway network and associated valve structure leading from the one or more fluid connections to a compressed air store via a first thermal energy store (TES) for storing and returning the heat of compression after the air has been compressed in the GT compressor, a second, higher pressure stage, variable mass flow, reversible power machinery for compressing the air to a higher pressure during a charging mode and expanding the air down from the higher pressure in a discharging mode, and a second thermal energy store (TES) for storing and returning the heat of compression after the air has been compressed in the reversible power machinery, all respectively arranged successively downstream of one another in the fluid passageway network, together with ancillary components such as heat exchangers or dehumidifying apparatus.

Each flow connection may be a bleed port or injection port, as opposed to a valve and may be as described in the 1st aspect.

Switching of the GT system from air being extracted from the GT system to air being injected into the GT system (eg. switching of the direction of the airflow to/from storage), or vice versa, while the GT is operating in the power generation mode, may be achieved (solely) by the reversible power machinery switching between acting as a compressor to acting as an expander, or vice versa.

Hence, whilst the GT system is operating continuously in a power generation mode, the reversible power machinery is able to reverse its functionality, and this reversal may be all that is required for the flow to/from storage to reverse, i.e. to switch the ACAES from operating in a charging (i.e. storage) mode to operating in a discharging mode, i.e. without, for example, opening or closing any valves in the valve structure (or, for the avoidance of doubt, without altering any valve arrangement in the gas turbine since this is of a normal configuration without any valve means for diverting the flow into or out of the GT). Thus, the valve structure between the compressed air store and gas turbine will usually be open and remain open during the switching. It may, however, also be desirable to make other adjustments for operating reasons such as adjusting the compressor geometry (e.g. inlet guide vanes to cope with the varying pressure ratio).

In one embodiment, the reversible power machinery is positive displacement machinery, preferably reciprocating positive displacement machinery. The positive displacement machinery may be piston based machinery. Switching of the piston based machinery between acting as a compressor and an expander, or vice versa, may be achieved solely by varying the valve timing.

In one embodiment, the reversible power machinery may be sized to match the maximum mass flow rate that is associated with the maximum power modulation required for the combustion turbine.

The role of the ACAES and reversible power machinery is merely to modulate the GT power, so it can be quite small power machinery. For example, the flow passageway network and thermal stores and the reversible power machinery all do not need to be sized to accommodate even 30% of the maximal mass flow rate that might pass through the GT compressor, for example, or even 25% of that maximum mass flow rate. Usually, these components will handle no more than 15% or even no more than 10% of the maximum flow rate through the GT.

In one embodiment, a charging compressor and associated air inlet may be disposed between the one or more fluid connections and the at least one direct TES for charging the compressed air store. The charging compressor and associated air inlet may allow the compressed air store to be charged in a charging mode when either the GT system is inactive, or, is active and generating power; but it is not desired to extract air from the GT system. Thus, while this embodiment involves more cost and complexity (although the charging compressor need only be matched to the desired maximum mass flow rate required for charging with it), it provides more flexibility.

The charging compressor may be operable in a power generation mode of the hybrid CTPGS in which pressurised air is supplied from the charging compressor to the GT system and injected at the one or more flow connections to supplement the airflow in the GT system, for example, when no compressed air from the compressed air store is available.

A pressure reducing device (that does no useful work when the gas is expanded) may be disposed in an alternative respective flow pathway between the at least one direct TES and the compressed air store, so that pressurised air from the compressed air store may either return to the at least one direct TES via the pressure reducing device, or, via the second thermal energy store (TES) and the reversible power machinery. This embodiment allows a rapid and larger modulation in power, in that the pressure reducing device can still be low cost but yet handle a much higher mass rate than the reversible power machinery, thereby allowing a much greater increase in power as air is injected into the GT system at a much higher rate than in the case of the reversible power machinery. This would allow a higher peaking power for a shorter period if the compressed air store were to be discharged in this way, as opposed to through the reversible machinery. Again, this provides more flexibility but greater complexity, although a pressure reducing device that does not capture useful work (e.g. throttle valve) is relatively low cost. For example, a reversible power machinery able to process 20 kg/s might be used for normal operation with the ability to modulate power by +/−22.5 MW for a CCGT. The pressure reducing device might be able to handle a further 20 kg/s, i.e. 40 kg/s, so the overall power modulation is from −22.5 MW to +42.5 MW.

The use of a direct TES for the first store is important for allowing the rapid response, as explained above in relation to the first aspect.

The second TES is exposed to higher pressures and hence is more usually an indirect store although it may also be a direct TES.

In one embodiment, the compressed air store is a variable pressure store and the second TES is capable of storing heat with a varying temperature profile. For example, if the second TES includes an indirect liquid store coupled by a heat exchanger, it would preferably be a stratified store storing heat of different temperatures at different respective layers, for example, progressively increasing temperatures in successive adjacent regions in one direction, so that the heat may be returned, in reverse order, as closely as possible to the original inlet temperatures. If the second TES is a direct store with a solid medium, it may be a simple monolithic or packed bed store, as opposed to a layered store.

There is further provided, in accordance with the second aspect, a method of operating a hybrid combustion turbine power generation system (CTPGS) including:

a combustion turbine (GT) system including a compressor, a combustor and a turbine fluidly connected downstream of each other, wherein the turbine is non-detachably coupled to the compressor and is operatively associated with a generator for power generation,

and an adiabatic compressed air energy storage system (ACAES) integrated therewith via one or more fluid connections disposed between the compressor and turbine, so as to allow air to be extracted from, and injected into, the GT system (e.g. upstream of the turbine);

wherein the ACAES includes a flow passageway network and associated valve structure leading from the one or more fluid connections to a compressed air store via a first direct thermal energy store (TES);

wherein a second, higher pressure stage, variable mass flow, reversible power machinery (that expands the gas doing useful work), and a second thermal energy store (TES) are arranged successively downstream (in the charging direction) of one another in the fluid passageway network;

the method including:

operating the hybrid CTPGS in a power generation mode in which air passes respectively downstream through the compressor, combustor and turbine of the GT system to generate power;

and, in that mode, using the reversible power machinery selectively to modulate the power output of the GT system in each of the following ways:
i. by operating it as a compressor and selectively adjusting its mass flow rate to vary (e.g. increase and decrease) the rate at which air is extracted from the GT system and passed to the compressed air store in an ACAES charging mode;
ii. by operating it as an expander and selectively adjusting its mass flow rate to vary (e.g. increase and decrease) the rate at which it withdraws air from the compressed air store for injection into the GT system in an ACAES discharging mode; and,
iii. by switching between it acting as a compressor to acting as an expander, or vice versa, so as to switch the ACAES from a charging mode in which air is being extracted from the GT system to a discharging mode in which air is being injected into the GT system, and vice versa.

In one embodiment, the reversible power machinery operates, and preferably it is sized to operate, with a mass flow rate through it of not more than 25% of the mass flow rate within the GT at the outlet of the GT compressor. By “sized to operate” it means that this mass flow rate is its maximum mass flow capacity. In this way, relatively low power machinery can be used to modulate the GT power output in a magnified manner to achieve considerable power modulation within the (unused) full theoretical capacity of the GT system, as described previously; moreover, where the GT is part of a CCGT, as opposed to a OCGT, the modulation effect is further magnified.

There is further provided, in accordance with the second aspect, a retrofit method in which an ACAES as specified above is retrofitted to an existing combustion turbine system as specified above in order to obtain a hybrid CTPGS as specified above.

In particular, there is provided a method of retrofitting an existing combustion turbine (GT) system at a power plant to incorporate an adiabatic compressed air energy storage (ACAES) system so as to provide a hybrid combustion turbine power generation system (CTPGS) as specified above, including the steps of:

a) installing at least one direct thermal energy store (TES) at the site of the existing GT system, which includes a compressor, a combustor and a turbine fluidly connected downstream of each other, wherein the turbine is non-detachably coupled to the compressor and is operatively associated with a generator for power generation;

b) providing or modifying one or more fluid connections disposed between the compressor and turbine, so as to allow air to be extracted from, and/or injected into, the GT system;

c) installing a flow passageway network and associated valve structure leading from the one or more fluid connections to a compressed air store via the at least one direct (TES);

d) optionally installing within the flow passageway network a charging compressor and associated air inlet disposed between the one or more fluid connections and the at least one direct TES for charging the compressed air store;

e) installing successively downstream of one another (in the charging direction) in the fluid passageway network: a second, higher pressure stage, variable mass flow, reversible power machinery (that expands the gas doing useful work), and a second thermal energy store (TES); and,

f) configuring the hybrid CTPGS to operate as specified above.

### BRIEF DESCRIPTION OF THE FIGURES

Specific embodiments of the present invention will now be described, by way of example only, with reference to the accompanying drawings in which:

FIG. 1 is a schematic diagram of a conventional combined cycle gas turbine (CCGT) system of the prior art;

FIG. 2a shows a first embodiment according to the first aspect of the present invention;

FIG. 2b shows a second embodiment according to the first aspect of the present invention;

FIG. 3a shows a first embodiment according to the second aspect of the present invention;

FIG. 3b shows a second embodiment according to the second aspect of the present invention; and,

FIG. 3c shows a third embodiment according to the second aspect of the present invention.

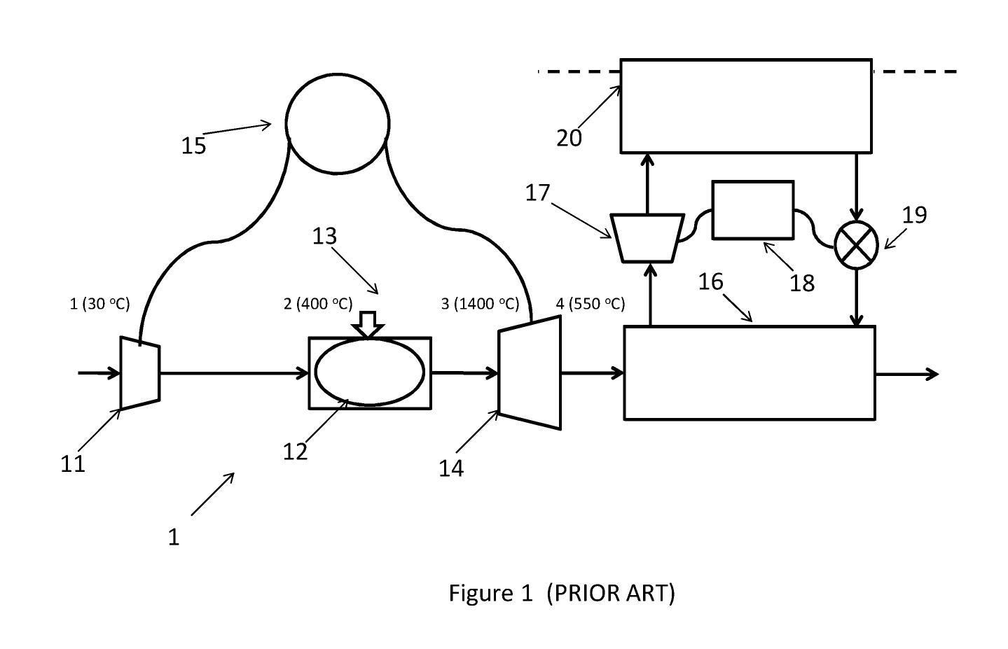

FIG. 1 shows a typical layout of a conventional prior art combined cycle gas turbine (CCGT) 1 used for peaking power generation, with an upstream compressor 11 directly coupled to a downstream turbine (expander) 14 and driving a generator 15 (e.g. connected to a transformer/grid). Between compressor 11 and turbine 14 is a combustion chamber 12 supplied with natural gas 13. In a normal configuration the compressor, turbine and generator are all directly coupled on the same shaft by drive couplings (not shown). Filtered air enters the compressor at ambient conditions (e.g. 30° C., 1 bar) and is compressed up to a higher pressure and temperature (e.g. 400° C., 16 bar). The hot high pressure air enters the combustion chamber where it is mixed with natural gas and caused to combust, heating the gas to a much higher temperature (e.g. 1400° C., 16 bar). This air is then expanded back to atmospheric pressure in the turbine, which produces more power than the compressor absorbs, hence there is a net generation of power that can drive the generator 15.

In the case of an open cycle gas turbine (OCGT), the cooled air is exhausted from the turbine well above ambient temperature (e.g. 450° C., 1 bar). However, in the case of a CCGT, the turbine operates with an exhaust temperature that is slightly hotter, either by operating at a lower pressure ratio or by combusting to a higher turbine inlet temperature. After the exhaust from the turbine 14, the hot high temperature exhaust gas (e.g. at 550° C., 1 bar) enters a heat exchanger 16, where it is cooled while heating a counterflow of water that is at high pressure. The water normally becomes superheated during the heat exchange process and is then expanded through steam turbine 17 to a lower pressure. This steam is then condensed in condenser 20 before being pumped back to a high pressure by water pump 19 to return to the heat exchanger 16. The condenser 20 is normally supplied with a cooling water flow from a river or the sea. Steam turbine 17 is normally directly coupled to water pump 19 by generator 18 and the expansion of the steam in the steam turbine 17 produces more power than the water pump 19 absorbs, resulting in a supplementary net production of power.

The remaining figures show embodiments according to the present invention. All embodiments relate to a conventional combustion turbine arrangement in which the compressor, combustor and turbine are permanently fluidly connected downstream of each other, so that whenever the gas turbine is operating at least some air flow passes successively downstream through all those components in turn, regardless of whether or not a portion of the flow is being extracted or augmented at the one or more fluid connections, and in that the turbine is non-detachably coupled to the compressor so that both operate together when power is being generated by the turbine.

Further, all embodiments are depicted as simple cycle gas turbine systems (OCGT), but may instead form part of a combined cycle gas turbine system (CCGT), or any other suitable derivative combustion turbine plant.

### 1st Aspect

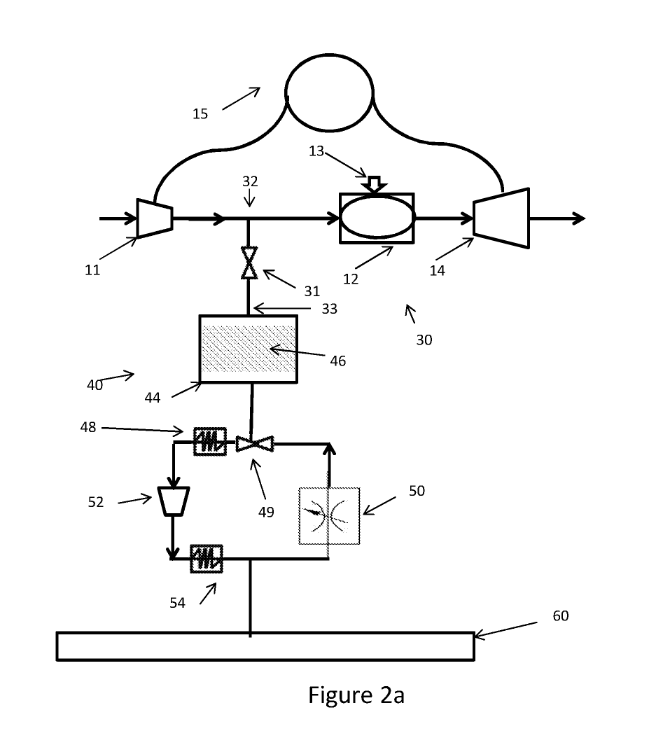

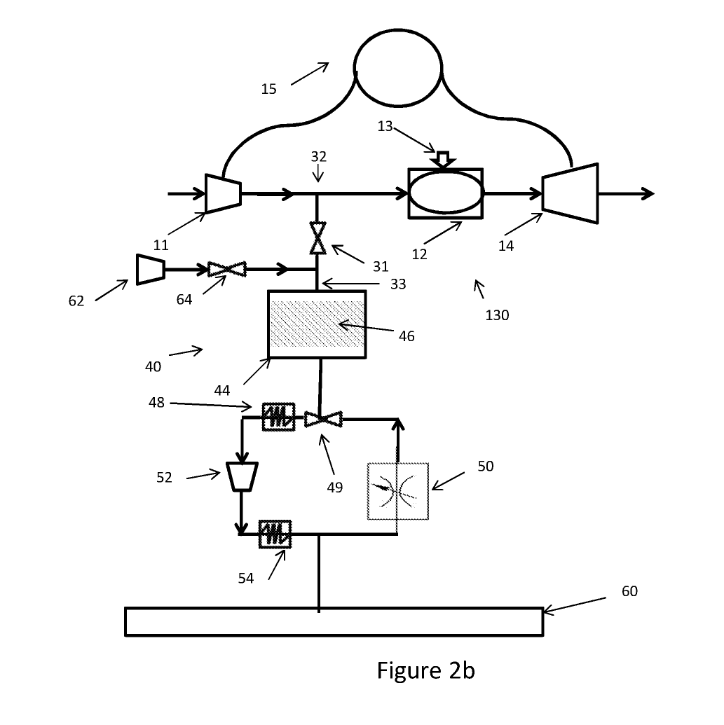

FIG. 2a shows a first embodiment according to the first aspect of some the embodiments including a simple cycle gas turbine system (OCGT) 30. It could, however, instead form part of a combined cycle system (CCGT), as exemplified in FIG. 1.

As explained above, the GT is a conventional GT arrangement with an upstream compressor 11 directly (and non-detachably) coupled to a downstream turbine (expander) 14, which drives a generator 15 connected for example to a transformer/grid. Between compressor 11 and turbine 14 is a combustion chamber/combustor 12 with a fuel inlet 13.

An adiabatic compressed air energy storage system (ACAES) is integrated with the GT usually as a retrofit process. The ACAES is integrated via one or more fluid connections 32 disposed downstream of the compressor and upstream of the turbine, for example, at the compressor outlet, at the turbine inlet or inbetween those, for example, in the combustor casing. These allow a fraction of the airflow to be extracted from, and/or some pressurised air to be injected into the GT system upstream of the turbine, when it is active (with an airflow passing successively down through the compressor, combustor and turbine). The one or more fluid connections may be a single fluid connection or multiple connections, for example, for respective extraction and injection. For example, for a gas turbine with multiple can combustors, they may include individual ports into each combustor casing with a manifold connecting them all to the pressurised air supply.

The ACAES includes a flow passageway network 33 and associated valve structure configured to allow selective operation in various modes. Downstream of the fluid connection 32 there is a valve 31, at least one direct TES store 40, and then, after valve 49, a second stage compressor 52 disposed in a charging flow pathway, with a pressure reducing device 50 disposed in an alternative discharging flow pathway, both located between the direct TES 40 and a compressed air store 60.

In this case the alternative flow pathways are arranged in parallel. It will be appreciated that the alternative pathways need not be in parallel: compressor 52 and pressure reducing device 50 could be arranged in series along a single flow passageway with appropriate bypass pathways around each so as to allow their alternative operation in alternative respective charging and discharging flow pathways. However, in contrast to the discharging flow pathway, the charging flow pathway should usually include a heat exchanger 48 immediately upstream of the supplementary compressor 52 and a heat exchanger 54 immediately downstream thereof.

The direct TES system may include one or more thermal stores 40 based on direct heat transfer. The thermal store 40 may be a direct TES with solid thermal storage media 46 such as crushed rock, concrete or other suitable particulate material and a thermally insulated vessel 44. Alternatively it may have more structured material such as formed ceramic blocks. The store may have a monolithic or packed bed structure and be a layered or unlayered design. In particular, thermal media 46 may include a packed bed of suitable thermal media such as high temperature concrete, ceramic components, refractory materials, natural minerals (crushed rock) or other suitable material.

Thermally insulated vessel 44 must be designed so that the high pressure flow (usually at between 15 and 25 bar and between 450-600° C.) can pass through the vessel transferring heat directly to/from the thermal media 46 at the required charging rate and discharging rates. As the media 43 is in the form of a packed bed with direct heat exchange to compressed gas, the thermally insulated vessel 44 will need to be an insulated pressure vessel.

In FIG. 2a, in a charging (to storage) mode, the gas turbine 11/12/14 is in operation generating power.

Valve 31 (which may merely be an on/off valve, but is preferably also a flow control valve) must be opened and pressure equalised between the thermal store 40 and the connection to the gas turbine. Valve 49 (which may merely be an on/off duct selector) is set to ensure that any flow must pass via compressor 52.

Compressor 52 starts operation and compresses air that is drawn from store 40 and hence from the gas turbine 30 up to a higher pressure. This high pressure gas is hotter than when it enters the compressor 52 and passes through heat exchanger 54 where it is cooled before entering the high pressure compressed air storage 60. Ideally the air is cooled to near ambient in heat exchanger 54.

The gas turbine is now operating at a slightly reduced power output as some of the air post compressor 11 is bled off from the flow. Usually the percentage of the GT mass flow that is bled off is no more than 15%, more usually no more than 10%. This means that while the work of the compressor 11 is remaining constant the amount of gas entering the turbine 14 is reduced leading to a reduction in power output. The amount to be bled off is determined/controlled by the mass flow passing through supplementary compressor 52.

The air that is bled off passes through valve 31 and enters hot TES 40 where it is cooled as it transfers heat to the thermal media 46. Note that this is a direct TES where heat transfer occurs directly between the thermal media and the gas flow that is at or close to the gas turbine post-compression pressure.

The gas will normally exit the TES 40 at a temperature that is slightly elevated above ambient and it may be cooled back close to ambient in heat exchanger 48 before it is further compressed. Cooling the compressed air in this way reduces the work of compression in compressor 52 and, as this energy is not recovered upon discharge, this is preferable.

Supplementary (or second-stage) compressor 52 may be a reciprocating (e.g. piston based compressor), rotary, turbo, centrifugal or some other suitable form of compressor that can operate over the working range of the high pressure compressed air storage 60, which is likely to be at least 40 bar, more usually at least 60 or 80 bar.

The high pressure compressed air storage 60 may be a manufactured pressure vessel such as high pressure pipe or a welded steel vessel or a larger containment means such as an underground gas cavern. Compressed air storage 60 may be a variable or constant pressure air store, in which case supplementary compressor 52 may need to operate over a wide, or narrow pressure ratio.

Valve 50 (which is not used during charge) is a pressure reduction valve (e.g. throttle valve) that is designed to drop air at a certain mass flow rate from the pressure in the high pressure compressed air storage to the pressure in the hot TES 40. Valve 31 on discharge may also act as a pressure reduction valve (that is able to regulate mass flow), however this operates over a much smaller pressure ratio. For example valve 50 may be designed to operate at a pressure ratio as high as 5:1 ie dropping pressure from 100 bar to 20 bar, whereas valve 31 may only be designed to drop pressure over a pressure ratio of 1.25:1, ie. 20 bar to 16 bar. Usually, valve 50 will drop the pressure by a ratio that is more than 1.5:1 (e.g. the ratio could be 3:1 or 4:1), while valve 31 located between the first TES and GT will drop the pressure by a ratio that is less than 1.5:1 (e.g. the ratio could be 1.2:1 or 1.4:1).

In a discharging mode valve 49 is set to ensure that flow passes via valve 50 and valve 31 is in an open position and preferably acting as a pressure reduction valve as described above.

Gas Turbine 30 is in operation and likely to be at or near full power. Note it will be understood by one skilled in the art that the power output of a gas turbine varies with temperature. Most gas turbines are rated for ISO conditions (ie 15° C.), however they can normally generate power at between 10-15% higher than this rating in very cold conditions (0° C. or lower). Likewise in very hot conditions they may generate 10-15% less than the ISO rating. Consequently a gas turbine may be operating at full capacity for the current inlet conditions, but still be operating at a power well below its maximum capability.

Valve 50 is opened and allows a certain mass of gas to pass through the valve with a controlled pressure drop. The lower pressure gas passes through hot TES 40 where it is heated up before passing through valve 31, where the pressure may be dropped further, before then entering the gas turbine post the compressor. In this way additional mass is added to the airflow stream that does not require power from the compressor (as it has previously been compressed), but additional fuel may be burnt and the mass flow through the turbine increased. In this way for a 5% mass flow addition it is possible to boost the output of a CCGT by as much as 8-9%.

The mass flow rate on discharge is much higher than the flow rate on charge. It may be twice, three times, or five times more or even ten times more than the mass flow rate on charge. Consequently there is likely to be a much higher pressure drop as the flow passes through the TES and also in the ducting and pipework that connects it to the gas turbine. As a result it is likely that the pressure in the TES 40 will be higher on discharge than on charge, potentially several bar higher. (For example, the pressure could be 20 bar upstream of TES and 17 bar downstream of the TES i.e. at GT). The important point is that the condition of the gas entering the gas turbine is at the right conditions for the gas turbine i.e. correct flow rate and pressure. The direct TES 40 may be designed with a shorter aspect ratio than required if it was only exposed to the charging conditions, that is, the width/bore is likely to be greater and the length shorter to accommodate the higher mass flow discharge rate. The use of a layered store as described previously may allow a reduction in the store length, by more effective control of the thermal front properties, according to Applicant's earlier patent publication number WO2012/127178.

A large direct thermal store may have a significant amount of the volume occupied by compressed air. This volume may create a lag between increasing the mass flow into the direct TES and seeing the flow rate into the gas turbine increase. Consequently, using two pressure reduction valves is likely to give additional control over this, with valve 50 acting as ‘coarse’ control and valve 31 acting as ‘fine’ (fast) control.

In this way a system is provided that uses minimal machinery (ie just compressor 52) to give a significant and rapid increase in power output. The amount of air in high pressure compressed air storage will determine how long this ‘boost’ can last for. For example using a charging mass flow of 3 kg/s, compressor 52 might use on average 400 kW, while charging the high pressure compressed air storage. There will also be a drop in gas turbine power output of about 3 MW as there is less mass flowing through the turbine and energy is still required for the compression. On discharge the mass flow rate might be 40 kg/s and the increase in power output of a CCGT might increase by 40 MW. This extra power is very high compared to the addition of a single compressor that only uses 400 kW on average ie it is 100 times higher.

FIG. 2b shows a second embodiment according to the first aspect of the present invention.

This system 130 is similar in principle to FIG. 2a, but there is the addition of a charging compressor 62 that acts (at least) as an alternative first stage compressor; this has its own upstream inlet and a downstream valve 64 (which is an on/off valve). The presence of charging compressor means that charging of the high pressure compressed air store can occur while the gas turbine is inactive, or while it is active but in order to avoid reducing power output of the gas turbine.

In a charging mode where the gas turbine is inactive, valve 31 is closed and valve 64 is open. Charging compressor 62 provides hot high pressure air to hot TES 40, which cools the air before further compression in supplementary compressor 52 as previously described.

If the gas turbine is operating/active and air is supplied from both charging compressor and the gas turbine then both valve 31 and 64 must be open. Compressor 52 must also be sized for the maximum combined mass flow rate.

Multiple charging modes are potentially available which include charging from charging compressor 62, a combination of charging compressor 62 and bleed air from the gas turbine or just bleed air from the gas turbine.

In a discharging mode, there is the normal discharging mode as described above in relation to FIG. 2a. There is also a slightly enhanced mode where discharging occurs and charging compressor 62 also operates with valve 64 open to increase the mass flow into the gas turbine. This has a slightly reduced benefit as the charging compressor 62 requires power to drive it.

There is a further mode of generation where valve 64 and 31 are open, valve 49 is shut, no flow passes through TES and charging compressor 62, simply enhances the power output of the gas turbine.

### First Aspect Example—Trickle Charge with Charging Compressor

TABLE 1
Effect of GT Inlet Temp on Power

| Inlet Temp/° C. | CCGT Gas Turbine Power Out/MW |
|---|---|
| −5 | 340 |
| 15 | 315 |
| 35 | 285 |

The GT system may operate at or near its maximum operating power at elevated ambient temperatures and/or at low air density/high elevation by augmenting the mass flow rate through the GT system with compressed air from storage.

It will be understood by one skilled in the art that injecting air between compressor and turbine will tend to raise the compression ratio that the compressor must operate over. The limit to how much the pressure can be raised is related to the stall characteristics of the compressor. The surge line is used to define an area of operation where the compressor will stall. Compressor stall is potentially damaging to the compressor as the airflow will discharge at a very rapid rate in a reverse direction through the compressor.

The gas turbine will be designed for a maximum torque that is related to the maximum power operating condition i.e. at low temperatures and sea level. The gas turbine can have air injected to raise operation to this maximum torque condition as long as the compressor does not stall. Consequently it may be beneficial to fit surge (stall) detecting devices to ensure that air can be injected at rates that push the GT close to the surge line without pushing it over the surge line.

Different compressors will have different design points and consequently, the amount of air that may be safely injected while remaining below the surge line means that they cannot get to the maximum operating power condition.

TABLE 2
Trickle Charge with Charging Compressor

| | | | Discharging | Discharging |
|---|---|---|---|---|
| | | Charging | at 35° C. | at 15° C. |
| | | at 35° C. | for 2 h with | for 4 h with |
| | Physical | for 16 h | 50 MW | 25 KW |
| Component | Data | at 3.5 MW | Boost | Boost |
| CCGT | 285 MW at | POWER IN | POWER | POWER |
| Gas Turbine | 35° C. Inlet | 285 MW at | OUT | OUT |
| | Temp | 35° C.- | 285 + 50 = | 315 + 25 = |
| | | 3.5 MW | 335 MW | 340 MW |
| | | for boost and | | |
| | | second stage | | |
| | | compressors | | |
| Boost | 2.5 MW | 5.5 kg/s mass | | |
| Compressor | Max 17 bar | flow rate | | |
| Direct TES | 650 tons | 5.5 kg/s mass | 50 kg/s mass | 25 kg/s mass |
| | | flow rate | flow rate | flow rate |
| Second | Varies | 5.5 kg/s mass | | |
| Stage | between | flow rate | | |
| Compressor | 0.2 MW | and | | |
| | 1 MW | | | |
| | Max 70 bar | | | |
| Pressure | Max 50 kg/s | | 50 kg/s mass | 25 kg/s mass |
| Reduction | | | flow rate | flow rate |
| Valve | | | | |
| High | Max 70 bar | | | |
| Pressure | | | | |
| Pipeline | | | | |

### Second Aspect

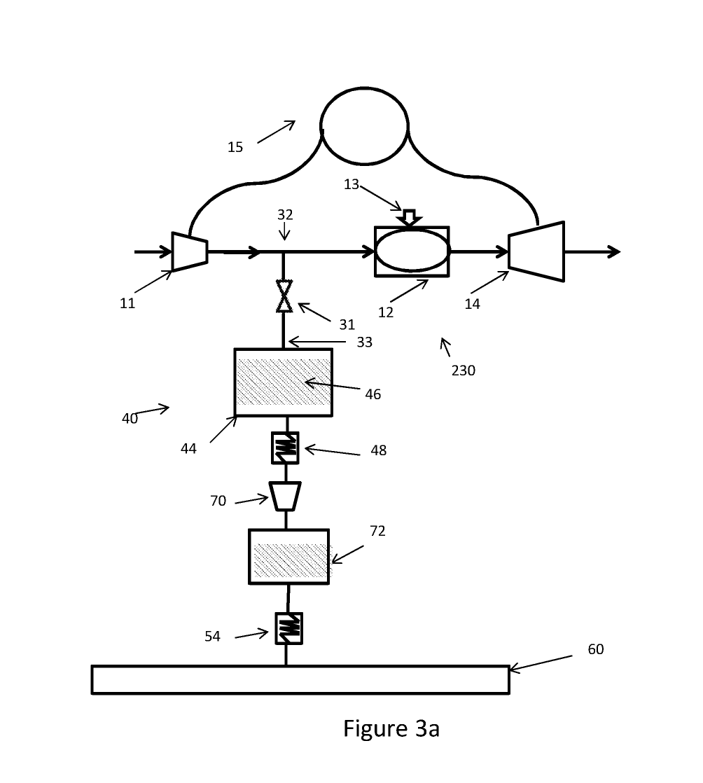

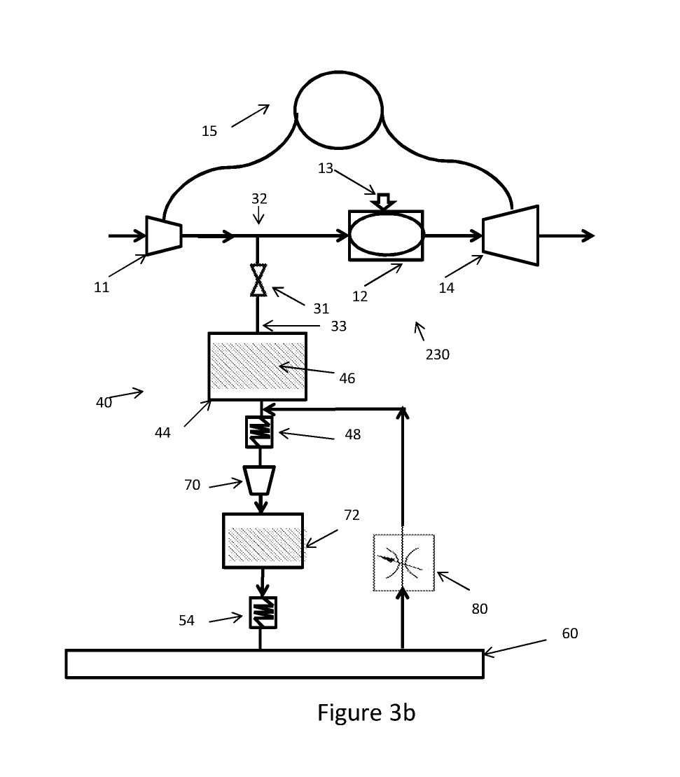

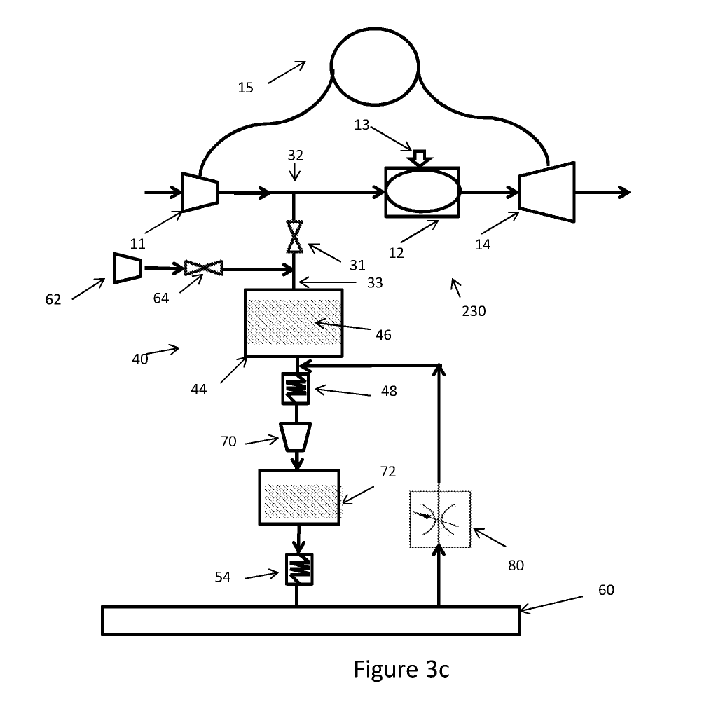

FIG. 3a shows a first embodiment according to the second aspect of the present invention.

In this embodiment the circuit is modified from that shown in FIGS. 2a and 2b, although the gas turbine components, the first direct TES, and the compressed air store remain unchanged. Compressor 52 is replaced with a reversible compressor/expander 70, which may be a positive displacement device, such as a reciprocating piston compressor that is able to vary between compressing and expanding gas by changing of valve timing. Valve 50 is removed and a second stage TES 72 is added, which may be either a direct TES or an indirect TES. If it is an indirect TES, then there will need to be a heat transfer fluid and a storage medium that is not at the same pressure as the compressed air.

The second aspect of the invention is concerned with the ability rapidly to modulate the power output of the gas turbine. For example, in a charging mode compressor/expander 70 acts as a compressor and draws bleed air from the gas turbine through TES 40, where the hot compressed air is cooled. It is further cooled as it passes through heat exchanger 48 before being compressed to a higher pressure. The hot high pressure air passes through the second hot TES where it is cooled before entering heat exchanger 54 and then high pressure compressed air storage 60. Heat exchanger 54 will preferably cool the gas to near ambient temperature.

In this way if compressor/expander is processing 15 kg/s of air then on average it will use 2 MW. However, it will reduce the output power of the gas turbine by 15 MW ie an overall reduction in power of 17 MW (15 MW+2 MW).

By changing function from compressor to expander the compressor/expander 70 will move between charging and discharging modes.

In a discharging mode high pressure air exits high pressure compressed air store 60 and passes, via exchanger 54, which may or may not be active, into second hot TES where it is heated up prior to expansion in compressor/expander 70. Post expansion the temperature should be near ambient, although machine losses mean that it may be slightly higher. The addition of heat in the TES is important to ensure there is no ice formation in compressor/expander 70. If necessary it is further cooled in heat exchanger 48 before entering hot TES 40 where it is reheated before being added to the gas turbine air flow.

In this way the addition of 15 kg/s will change the power output from a charging mode being 17 MW lower than normal power to almost 17 MW higher ie a modulation of 34 MW for the addition of a single compressor/expander with average power requirement of +/−2 MW. Note there are some losses that mean that the there will be a difference between the charging power reduction and discharging power boost—ie there are some system losses that mean the boost MW will be lower than the power reduction if carried out for equal periods of time.

In this embodiment thermal store 72 needs to be sized so that there is sufficient thermal capacity for all of the gas stored. Furthermore the temperature of the compressed air post compressor/expander 70 will increase as the pressure in high pressure compressed air storage 60 increases. This means that it is preferable if thermal store 72 can store heat with a varying temperature profile. For example, if the second TES is an indirect liquid store (coupled via a heat exchanger), it would preferably be a stratified store, and storing heat of different temperatures at respective layers, for example, progressively increasing temperatures in successive adjacent regions in one direction, so that the heat may be returned, in reverse order, as closely as possible to the original inlet temperatures. If the second TES is a direct store with a solid medium, it will be a simple monolithic or packed bed store, as opposed to a layered store.

FIG. 3b shows a second embodiment according to the second aspect of the present invention. In this embodiment the thermal store 72 does not need to be designed to store a quantity of heat that is equal to all of the heat of compression. The store may be ‘overcharged’ and some heat maybe rejected via heat exchanger 54.

The invention has an additional bypass flow via pressure regulator valve 80, which means that if an additional and further power boost is required then this can occur in parallel with discharging via compressor/expander 70. For example compressor expander 70 could be processing 15 kg/s and boosting GT power output by 17 MW while a further 35 kg/s can be discharged through pressure reduction valve 80. In this way GT output can be boosted by approximately 52 MW.

The efficiency of the discharge via the pressure reduction valve will be lower than that of the compressor/expander 70, however the cost of the additional extra power boosting is very low. The hot TES 40 must be able to cope with the combined mass flow of both ie 50 kg/s, while the second TES 72 only needs to cope with the flow going through the compressor/expander 70 ie 15 kg/s.

It is preferable if the compressor/expander 70 does not continue discharging when the second TES 72 is discharged as it may lead to issues with ice formation in the machine.

In all of the FIGS. 3a to 3c embodiments, although not shown, a shut off valve may be interposed in the flow passageway anywhere between the reversible power machinery and the compressed air store in order that when the ACAES is not actively charging or discharging but is instead storing compressed air, then the shut-off valve seals off the system on the higher pressure side of the reversible machinery.

FIG. 3c shows a third embodiment according to the second aspect of the present invention.

This figure is similar to FIG. 3b, but with the addition of a charging compressor 62 and valve 64.

In this way it is possible to have multiple charging modes as described in FIG. 2b ie charging from main GT via an air bled, via charging compressor and/or a combination of both.

It is also possible now to have additional discharge or boosting modes that include:

i. discharging via compressor/expander 70 with and without charging compressor 62 running
ii. discharging via pressure reduction valve 80 with and without charging compressor 62 running
iii. discharging via combination of compressor/expander 70 and pressure reduction valve 80 with and without charging compressor 62 running.
iv. charging compressor 62 running to deliver some boost power to GT and some charging airflow to compressor/expander 70.
v. charging compressor 62 running to boost GT power without any going to charging system.

As a related matter, variable inlet guide vanes, variable exit guide vanes and variable compressor geometry may be used either individually or in combination to help prevent compressor stall when using augmented mass flows. Increasing the mass flow rate of air returning from storage, for example, may affect compressor flow by changing the pressure and flow conditions at the compressor exit. If the compressor flow rate changes, the compressor guide vanes can be rotated so as to maintain correct incidence at critical compressor stages (either inlet or exit) to increase stall margin and allow for more augmented mass flow injection.

Features described in relation to one aspect may be used in connection with the other aspect, where this is not inconsistent with the latter aspect.

While the present invention has been described in detail with reference to certain preferred embodiments, other embodiments of the invention are possible. Therefore, the scope of the appended claims should not be limited to the description of the preferred embodiments contained herein. As previously mentioned, the CTPGS may be a simple cycle SCOT/open cycle OCGT, with only one power cycle and no provision for waste heat recovery, or it may be any known or suitable future variant or derivative thereof which could still benefit from integration of the first and/or second aspects described above, such as a combined cycle gas turbine CCGT (i.e. with a steam turbine bottoming cycle in addition to the topping cycle), or a variant thereof, for example, a CTPGS with intercooling, reheat, recuperation, or with steam injection.

1. A hybrid combustion turbine power generation system (CTPGS) comprising:
a combustion turbine (GT) system that includes a compressor, a combustor and a turbine fluidly connected downstream of each other, wherein the turbine is non-detachably coupled to the compressor and is operatively associated with a generator for power generation, and an adiabatic compressed air energy storage system (ACAES) integrated therewith via one or more fluid connections disposed between the compressor and turbine, so as to allow air to be extracted from, and/or injected into, the GT system, wherein the ACAES includes a flow passageway network and associated valve structure leading from the one or more fluid connections to a compressed air store via at least one direct thermal energy store (TES),
there being further disposed within the flow passageway network (i) an optional, charging compressor and associated air inlet disposed between the one or more fluid connections and the at least one direct TES for charging the compressed air store, and (ii) a supplementary compressor and a pressure reducing device disposed in alternative respective flow pathways between the at least one direct TES and the compressed air store,
wherein the flow passageway network and associated valve structure is configured to allow selective operation of the ACAES in both:
a charging mode in which compressed air at a first mass flow rate is supplied by the compressor of the GT system and/or the optional charging compressor to the at least one direct TES, where it passes through and is cooled by the at least one direct TES, and the compressed, cooled air is further compressed by the supplementary compressor before being stored in the compressed air store; and,
a discharging mode, in which pressurized air from the compressed air store at a second mass flow rate that is higher than the first mass flow rate, is expanded by the pressure reducing device, and passes through the at least one direct TES where it is heated, before passing via the one or more fluid connections back into the combustor to supplement the air flow therethrough; and,
wherein the CTPGS is configured to allow selective operation in at least each of the following operating modes:
(i) a normal power generation mode in which air passes respectively downstream through the compressor, combustor and turbine of the GT system to generate power, but the air flow is not partially supplemented or extracted;
(ii) another power generation mode in which air passing respectively downstream through the compressor, combustor and turbine of the GT system to generate power is supplemented by the injection, at the one or more fluid connections, of pressurized air that is returning at the second mass flow rate from the compressed air store of the ACAES system as it operates in the discharging mode specified above; and,
(iii) a storage mode in which at least one of the following occurs:
(a) compressed air from the charging compressor, when present, is supplied at the first mass flow rate to the at least one direct TES, and the GT system is either inactive, or, is active and generating power; and
(b) compressed air is extracted via the one or more fluid connections from the GT system and supplied at the first mass flow rate to the at least one direct TES.

2. The hybrid CTPGS according to claim 1, wherein the second mass flow rate is at least twice the first mass flow rate.

3. The hybrid CTPGS according to claim 1, wherein, in the charging mode, some of the compressed air passing through the GT system is extracted at the one or more fluid connections and supplied at the first mass flow rate to the at least one direct TES.

4. The hybrid CTPGS according to claim 1, wherein the charging compressor having the associated air inlet is provided between the one or more fluid connections and the direct TES and, in the charging mode, compressed air at the first mass flow rate is supplied by the charging compressor to the at least one direct TES.

5. The hybrid CTPGS according to claim 1, wherein, in the charging mode, some of the compressed air passing through the GT system is extracted at the one or more fluid connections; and,
wherein the charging compressor having the associated air inlet is provided between the one or more fluid connections and the direct TES; and,
in the charging mode, compressed air at the first mass flow rate is supplied by the charging compressor and by extraction from the GT system to the at least one direct TES.

6. The hybrid CTPGS according to claim 1, wherein a flow regulating valve is provided in the flow passageway network between the one or more fluid connections and the direct TES that controls the flow rate in a discharging mode so as to regulate the GT power output.

7. The hybrid CTPGS according to claim 1, wherein the at least one direct TES includes a direct transfer, sensible heat store includes a solid thermal storage medium disposed in respective, downstream, individually access controlled layers.

8. The hybrid CTPGS according to claim 1, wherein the compressed air store includes a variable pressure, compressed air store.

9. The hybrid CTPGS according to claim 1, wherein the compressed air store includes one or more pipelines.

10. The hybrid CTPGS according to claim 1, wherein the charging compressor is present and the CTPGS is configured to allow selective operation in:
(iv) a further power generation mode in which pressurized air is supplied from the charging compressor to the GT system and injected at the one or more flow connections to supplement the airflow in the GT system.

11. The hybrid CTPGS according to claim 10, wherein the CTPGS is configured to allow selective operation in:
(v) an alternative further power generation mode in which, in addition to the pressurized air being supplied from the charging compressor to the GT system and injected at the one or more flow connections to supplement the airflow in the GT system, pressurized air returning from the compressed air store is injected at the one or more flow connections to supplement the airflow in the GT system.

12. A method of operating a hybrid combustion turbine power generation system (CTPGS) that includes a combustion turbine (GT) system having a compressor, a combustor and a turbine fluidly connected downstream of each other, wherein the turbine is non-detachably coupled to the compressor and is operatively associated with a generator for power generation, and an adiabatic compressed air energy storage system (ACAES) integrated therewith via one or more fluid connections disposed between the compressor and turbine, so as to allow air to be extracted from, and/or injected into, the GT system, wherein the ACAES includes a flow passageway network and associated valve structure leading from the one or more fluid connections to a compressed air store via at least one direct thermal energy store (TES), there being further disposed within the flow passageway network (i) an optional, charging compressor and associated air inlet disposed between the one or more fluid connections and the at least one direct TES for charging the compressed air store, and (ii) a supplementary compressor and a pressure reducing device disposed in alternative respective flow pathways between the at least one direct TES and the compressed air store, wherein the flow passageway network and associated valve structure is configured to allow selective operation of the ACAES in both a charging mode in which compressed air at a first mass flow rate is supplied by the compressor of the GT system and/or the optional charging compressor to the at least one direct TES, where it passes through and is cooled by the at least one direct TES, and the compressed, cooled air is further compressed by the supplementary compressor before being stored in the compressed air store; and a discharging mode, in which pressurized air from the compressed air store at a second mass flow rate that is higher than the first mass flow rate, is expanded by the pressure reducing device, and passes through the at least one direct TES where it is heated, before passing via the one or more fluid connections back into the combustor to supplement the air flow therethrough; the method comprising:
selectively operating the CTPGS in at least each of the following operating modes:
(i) a normal power generation mode in which air passes respectively downstream through the compressor, combustor and turbine of the GT system to generate power, but the air flow is not partially supplemented or extracted;
(ii) another power generation mode in which air passing respectively downstream through the compressor, combustor and turbine of the GT system to generate power is supplemented by the injection, at the one or more fluid connections, of pressurized air that is returning at the second mass flow rate from the compressed air store of the ACAES system as it operates in the discharging mode specified above; and,
(iii) a storage mode in which at least one of the following occurs:
(a) compressed air from the charging compressor, when present, is supplied at the first mass flow rate to the at least one direct TES, and the GT system is either inactive, or, is active and generating power;
(b) compressed air is extracted via the one or more fluid connections from the GT system and supplied at the first mass flow rate to the at least one direct TES.

13. (canceled)

14. The method of retrofitting an existing combustion turbine (GT) system at a power plant to incorporate an adiabatic compressed air energy storage (ACAES) system so as to provide a hybrid combustion turbine power generation system (CTPGS) according to claim 1, comprising:
a) installing at least one direct thermal energy store (TES) at the site of the existing GT system, which includes a compressor, a combustor and a turbine fluidly connected downstream of each other, wherein the turbine is non-detachably coupled to the compressor and is operatively associated with a generator for power generation;
b) providing or modifying one or more fluid connections disposed between the compressor and turbine, so as to allow air to be extracted from, and/or injected into, the GT system;
c) installing a flow passageway network and associated valve structure leading from the one or more fluid connections to a compressed air store via the at least one direct (TES);
d) optionally installing within the flow passageway network a charging compressor and associated air inlet disposed between the one or more fluid connections and the at least one direct TES for charging the compressed air store;
e) installing a supplementary compressor and a pressure reducing device disposed in alternative respective flow pathways within the flow passageway network between the at least one direct TES and the compressed air store; and
f) configuring the hybrid CTPGS to operate as specified in claim 1.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A method according to claim 12, wherein the second mass flow rate is at least twice the first mass flow rate.

33. The method according to claim 12, wherein, in the charging mode, some of the compressed air passing through the GT system is extracted at the one or more fluid connections and supplied at the first mass flow rate to the at least one direct TES.

34. The method according to claim 12, wherein the charging compressor having the associated air inlet is provided between the one or more fluid connections and the direct TES and, in the charging mode, compressed air at the first mass flow rate is supplied by the charging compressor to the at least one direct TES.

35. The method according to claim 12, wherein the charging compressor is present and the CTPGS operates in:
(iv) a further power generation mode in which pressurized air is supplied from the charging compressor to the GT system and injected at the one or more flow connections to supplement the airflow in the GT system.

36. The method according to claim 35, wherein the CTPGS is configured to allow selective operation in:
(v) an alternative further power generation mode in which, in addition to the pressurised air being supplied from the charging compressor to the GT system and injected at the one or more flow connections to supplement the airflow in the GT system, pressurized air returning from the compressed air store is injected at the one or more flow connections to supplement the airflow in the GT system.
